(19) United States
(12) Patent Application Publication
(10) Pub. No.: US 2026/0145191 A1
(43) Pub. Date: May 28, 2026

(54) ONE-COMPONENT APPLICATOR

(71) Applicant: Clayton Corporation, Fenton, MO (US)

(72) Inventor: William A. Adams, Fenton, MO (US)

(21) Appl. No.: 19/398,600

(22) Filed: Nov. 24, 2025

Related U.S. Application Data
(60) Provisional application No. 63/724,308, filed on Nov. 23, 2024.

(51) Int. Cl. B05B 9/01; B05B 9/08

(52) U.S. Cl. CPC B05B 9/01; B05B 9/0805

(57) ABSTRACT

A hand-held applicator for a one-component flowable product comprises an applicator body including a handle configured to be gripped by a user and a trigger configured to be actuated by the user. A barrel is coupled to the applicator body and defines a fluid passage extending longitudinally therethrough. A pin is operatively coupled to the trigger and extends within the fluid passage. The pin selectively blocks flow through the fluid passage. A nozzle is coupled to a distal end of the barrel. The nozzle assembly includes an adapter threadably coupled to the barrel, a nut coupler threadably coupled to the adapter, and a nozzle insert retained between the adapter and the nut coupler. The nozzle insert is replaceable by unthreading the nut coupler from the adapter while the adapter remains coupled to the barrel.

### FIELD OF THE DISCLOSURE

The present disclosure generally relates to a hand-held applicator for a one-component flowable product.

### BACKGROUND OF THE DISCLOSURE

Applicators for dispensing flowable materials are used across various industries and applications. These devices enable controlled application of materials such as adhesives, sealants, foams, and other chemical products from pressurized containers. The materials may be dispensed from aerosol cans or supplied through hose connections from larger reservoirs.

Gun-type applicators typically include a body with a handle and trigger mechanism, a barrel defining a flow passage, and a dispensing nozzle at the distal end. The trigger controls a pin or valve mechanism that regulates material flow through the system. When actuated, the pressurized material flows from the source container through the barrel and exits through the nozzle.

### SUMMARY OF THE DISCLOSURE

Features of a hand-held applicator for a one-component flowable product are described and shown herein.

According to an aspect of the present disclosure, a hand-held applicator for a one-component flowable product is provided. The applicator includes an applicator body with a handle that a user can grip and a trigger that the user can operate. A barrel connects to the applicator body and contains a fluid passage that runs lengthwise through it. A pin connects to the trigger and extends inside the fluid passage, where it can block or allow flow through the passage. A nozzle assembly attaches to the end of the barrel and consists of three parts: an adapter that screws onto the barrel, a nut coupler that screws onto the adapter, and a nozzle insert that sits between the adapter and nut coupler. The nozzle insert can be replaced by unscrewing the nut coupler from the adapter while leaving the adapter attached to the barrel.

According to other aspects of the present disclosure, the hand-held applicator may include one or more of the following features. The adapter may have internal threads that connect with external threads at the end of the barrel. The adapter may have external threads that connect with internal threads of the nut coupler. The nozzle insert may have a flange at its back end that sits between the adapter and nut coupler. The nozzle insert may have a body that extends forward from the flange and contains a passage running through its length. The passage may end at a tip that controls how the flowable product sprays out. The applicator may include a basket assembly that connects to the applicator body and holds a container of pressurized flowable product.

According to another aspect of the present disclosure, an applicator for dispensing flowable material is provided. The applicator includes a gun body with a handle and trigger. A barrel extends from the gun body and contains an internal passage. A nozzle assembly sits at the end of the barrel and includes a first threaded part connected to the barrel, a second threaded part that screws into the first part, and a dispensing insert positioned between the two threaded parts. A flow control element moves within the internal passage to allow or block material flow.

According to other aspects of the present disclosure, the applicator may include one or more of the following features. The first threaded part may have internal threads that connect with external threads at the end of the barrel. The first threaded part may have external threads that connect with internal threads of the second threaded part. The dispensing insert may have a flange at its back end that sits between the first and second threaded parts. The dispensing insert may have a body that extends forward from the flange and contains a passage running through its length. The passage may end at a tip that controls how the flowable material sprays. The flow control element may be a pin connected to the trigger that can block an opening at the end of the internal passage.

According to another aspect of the present disclosure, a dispensing device is provided. The device includes a body portion designed for hand-held use. A tubular member connects to the body portion and has an internal flow path. A multi-part nozzle assembly sits at the end of the tubular member and includes threaded connections that allow the assembly to be taken apart for replacing parts. A movable element within the flow path controls material flow through the device.

According to other aspects of the present disclosure, the dispensing device may include one or more of the following features. The multi-part nozzle assembly may include an adapter that screws onto the tubular member, a nut coupler that screws onto the adapter, and a dispensing insert that sits between the adapter and nut coupler. The dispensing insert may have a flange at its back end that sits between the adapter and nut coupler and a body that extends forward from the flange. The body may contain a passage running through its length and ending at a tip that controls spray pattern. The movable element may be a pin connected to a trigger on the body portion that can block an opening in the internal flow path. The device may include a connection assembly that attaches to the body portion and receives a source of pressurized flowable material.

### BRIEF DESCRIPTION OF THE DRAWINGS

FIG. 1 is a perspective of an applicator for a one-component flowable product.

FIG. 2 is an exploded perspective of the applicator.

FIG. 3 is an exploded, cross section of a barrel and nozzle assembly of the applicator.

FIG. 4 is an enlarged perspective showing the nozzle assembly exploded from the barrel.

FIG. 5 is an enlarged, partial cross section of the distal end portion of the barrel and nozzle assembly coupled to the barrel.

FIG. 6 is a perspective of another embodiment of an applicator.

FIG. 7 is an elevation of the applicator of FIG. 7.

### DETAILED DESCRIPTION OF THE DISCLOSURE

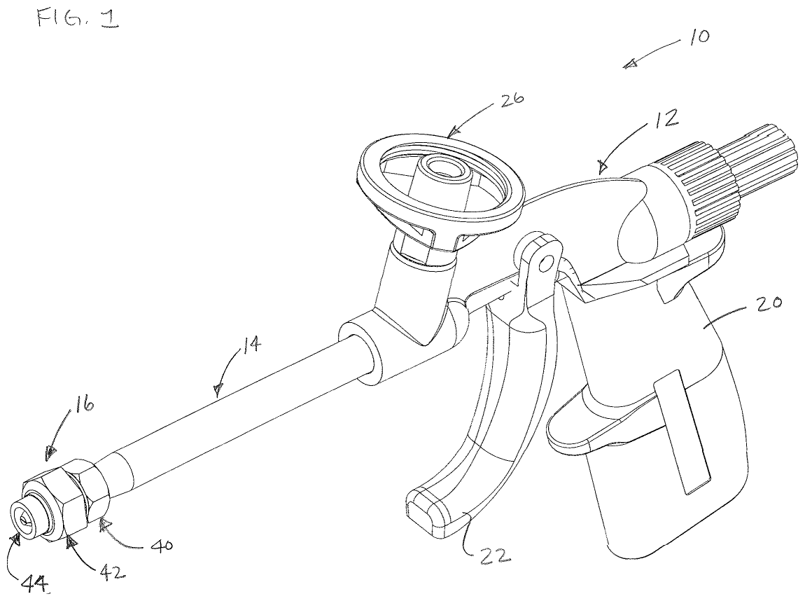

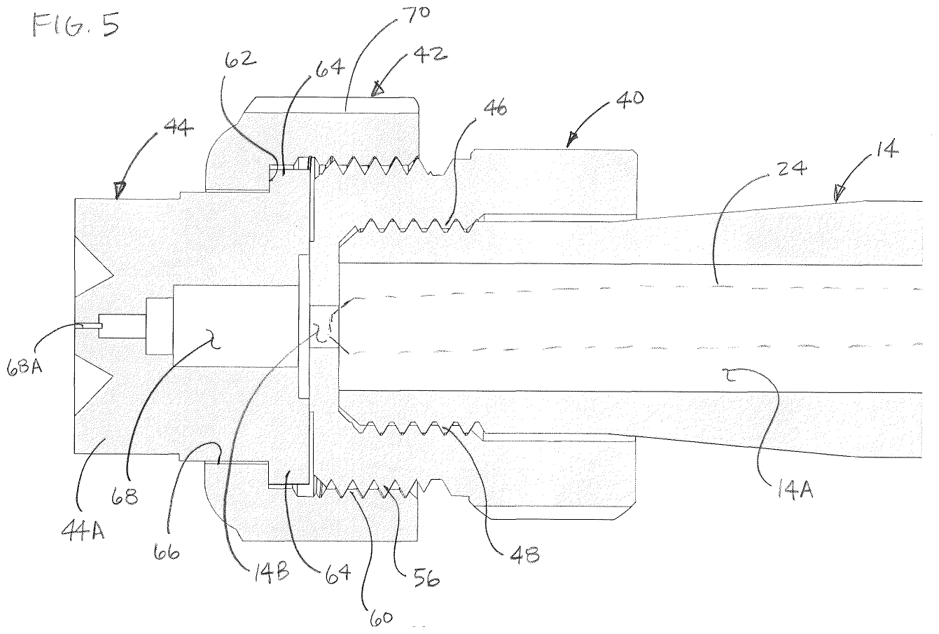

Referring to FIGS. 1 and 5, a hand-held applicator for a one-component flowable product is generally indicated at reference numeral 10. The applicator 10 is configured to enable application of a one-component flowable material (e.g., flowable chemical material, polyurethane foam, adhesive, etc.) contained under pressure in a container (e.g., aerosol can). In the illustrated embodiment, the applicator 10 is a gun type applicator including an applicator body (e.g., gun body), generally indicated at 12; a barrel, generally indicated at 14, coupled to the applicator body and defining a fluid passage 14A; and a nozzle assembly, generally indicated at 16, coupled to the barrel at a distal end thereof. As explained below, the applicator body 12 and the barrel 14 may have conventional designs and functions. As also explained below, the nozzle assembly 16 is configured to enable a user to selectively change a spray pattern or selectively use the applicator 10 for materials of different types and/or having different viscosities, for example.

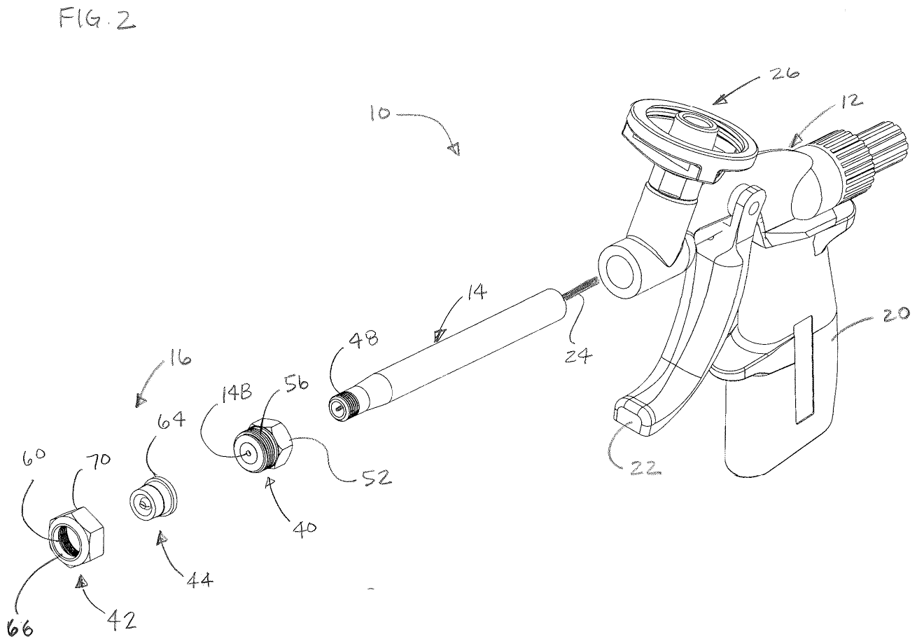

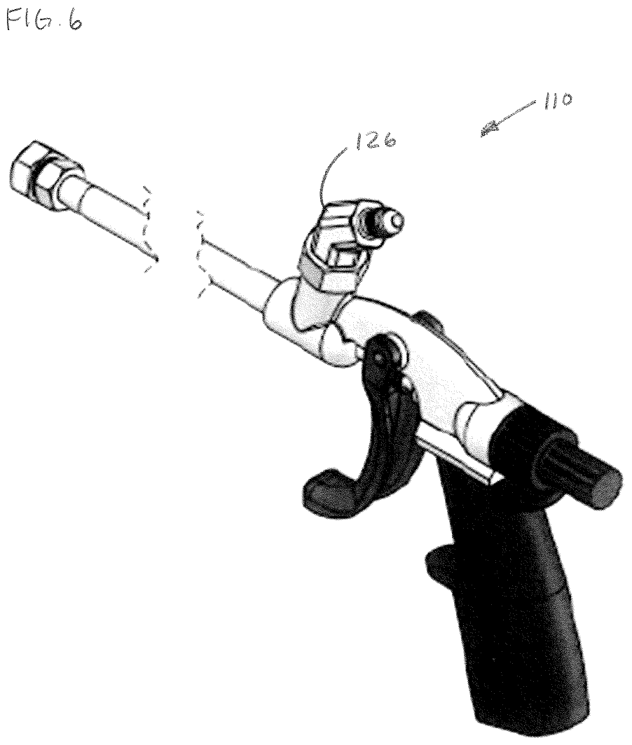

Referring to FIGS. 1-2, he applicator body 12 includes a handle 20 configured to be gripped by a hand of a user; a trigger 22 configured to be depressed by a finger(s) of the user to actuator the applicator 10; a pin 24 operatively coupled to the trigger and extending longitudinally within the fluid passage 14A of the barrel 14; and a basket assembly 26 in fluid communication with the fluid passage of the barrel and configured to enable an aerosol can, holding the flowable material or product under pressure, to be coupled thereto so that the aerosol can is in selective fluid communication with the fluid passage of the barrel. In operation, a can (e.g., aerosol can) holding flowable product under pressure is coupled to the basket assembly 26, such as by twisting an adaptor of the can on a basket body 26A of the basket assembly. As shown in FIG. 6, when the trigger 22 is not depressed or otherwise not actuated, a distal end of the pin 24 blocks (e.g., seated on) a distal opening 14B of the fluid passage 14A to inhibit dispensing of the flowable product from the applicator 10. When the trigger 22 is depressed or otherwise actuated, the pin 24 is retracted from the distal opening 14B (i.e., moved proximally relative to the barrel 14 such that the pressurized flowable from the can flows through the fluid passage 14A of the barrel 14, and into and through the nozzle assembly 16.

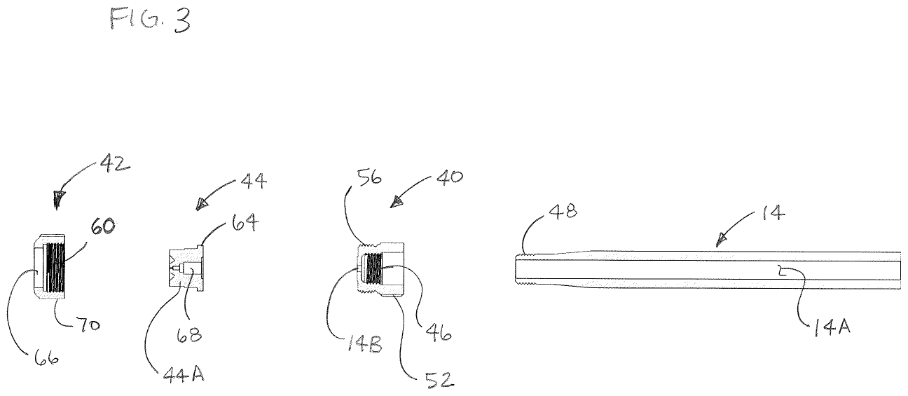

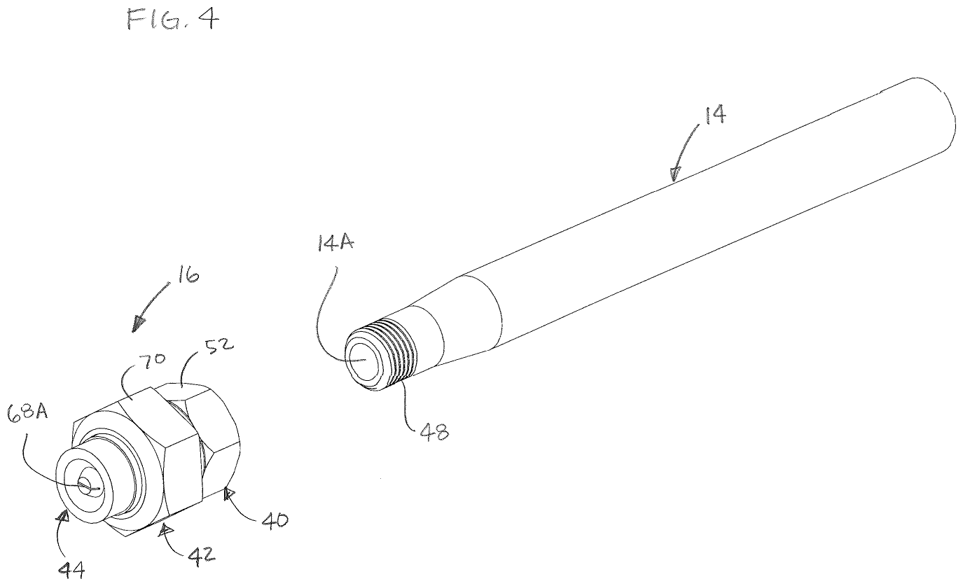

Referring to FIGS. 2-5, the nozzle assembly 16 is threadably coupled to the distal end of the barrel 14. The nozzle assembly 16 includes an adapter 40, a nut coupler 42, and a nozzle insert 44. Referring to FIGS. 3 and 5, the adapter 40 includes internal thread(s) 46 threaded on external thread(s) 48 at the distal end of the barrel 14. A distal wall of the adapter 40 defines the distal opening 14B of the fluid passage 14A and is configured to enable the distal end of the pin 24 to seat therein to seal the distal opening. A proximal portion 52 of the adapter 40 has a hexagonal (or other rectilinear) exterior to enable a wrench or other tool to be coupled thereto for threading the adapter on the barrel 14. A distal portion of the adapter 40 has external thread(s) 56.

Referring to FIGS. 3 and 5, the nut coupler 42 includes internal thread(s) 60 threaded on the external thread(s) 56 of the adapter 40. A distal, internal shoulder 62 of the nut coupler 42 engages a proximal flange 64 of the nozzle insert 44 to couple the nozzle insert 44 to the adapter 40. A body 44A of the nozzle insert 44 extends distally from the proximal flange 64 and is received in a distal opening 66 of the nut coupler 42. In the illustrated embodiment, the body 44A extends through the distal opening 66 and is exposed distally of the nut coupler 42. The nozzle insert 44 defines a nozzle passage 68 extending through proximal and distal ends of the nozzle insert. A distal end or tip 68A of the nozzle passage 68 defines a spray pattern of dispensed flowable product. At least a portion 70 of the nut coupler 42 has, for example, a hexagonal (or other polygonal) exterior to enable a wrench or other tool to be coupled thereto for threading and unthreaded the nut coupler on the adapter 40.

The nozzle insert 44 can be changed by unthreading the nut coupler 42 from the adapter 40 (such as by a wrench), removing the insert from the nut coupler, inserting a suitable nozzle insert with a different flow pattern or other feature into the nut coupler, and then threading the nut coupler with the other nozzle insert (such as by a wrench) onto the adapter. The adapter 40 remains threaded or otherwise coupled to the barrel 14 throughout this process. One of i) the threaded coupling of the barrel 14 and the adapter 40 and ii) the coupling of the nut coupler 42 and the adapter 40 may be reverse threaded so that the adapter does not unthread when unthreading the nut coupler 42 from the adapter.

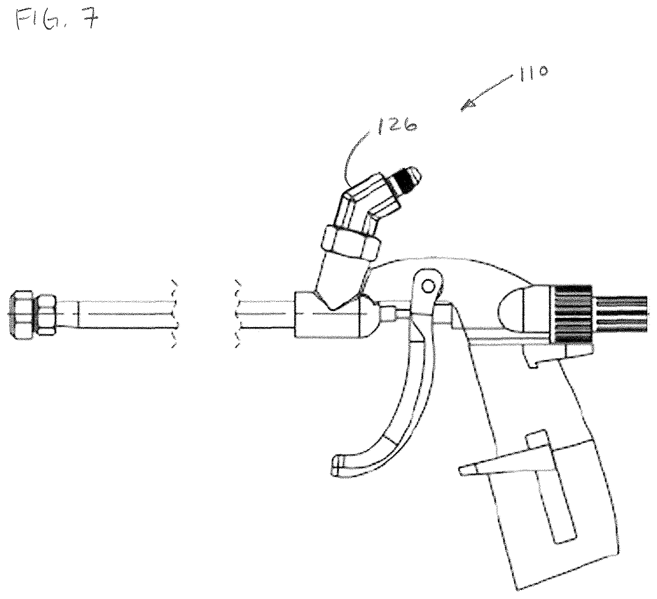

Referring to FIGS. 6 and 7, another embodiment of a hand-held applicator for a one-component flowable product is generally indicated at reference numeral 110. This embodiment is similar to the prior embodiment 10, except that the basket coupler 26 is replaced with an angled hose coupler 126 configured to fluidly connect the applicator 110 to a hose. The hose, in turn, may be fluidly coupled to a source of the one-component product. The illustrated angled hose coupler 126 is a 45-degree hose fitment. In another embodiment, the angle may be other than 45 degrees. The illustrated coupler 126 is a JIC fitment. One end may be configured to be threaded into the body of the applicator 126 and the other exposed end may be configured to thread or otherwise couple to a hose fitment. It is understood that the nozzle assembly 16 of the prior embodiment may be omitted in this embodiment.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A hand-held applicator for a one-component flowable product, comprising:
an applicator body including a handle configured to be gripped by a user and a trigger configured to be actuated by the user;
a barrel coupled to the applicator body and defining a fluid passage extending longitudinally therethrough;
a pin operatively coupled to the trigger and extending within the fluid passage, the pin configured to selectively block flow through the fluid passage; and
a nozzle assembly coupled to a distal end of the barrel, the nozzle assembly including an adapter threadably coupled to the barrel, a nut coupler threadably coupled to the adapter, and a nozzle insert retained between the adapter and the nut coupler, wherein the nozzle insert is replaceable by unthreading the nut coupler from the adapter while the adapter remains coupled to the barrel.

2. The hand-held applicator of claim 1, wherein the adapter includes internal thread configured to engage external thread at the distal end of the barrel.

3. The hand-held applicator of claim 2, wherein the adapter includes external thread configured to engage internal thread of the nut coupler.

4. The hand-held applicator of claim 1, wherein the nozzle insert includes a proximal flange retained between the adapter and the nut coupler.

5. The hand-held applicator of claim 4, wherein the nozzle insert includes a body extending distally from the proximal flange and defining a nozzle passage extending longitudinally therethrough.

6. The hand-held applicator of claim 5, wherein the nozzle passage terminates at a distal tip configured to control a spray pattern of the one-component flowable product.

7. The hand-held applicator of claim 1, further comprising a basket assembly coupled to the applicator body and configured to receive a container holding the one-component flowable product under pressure.

8. An applicator for dispensing flowable material, comprising:
a gun body having a handle and a trigger;
a barrel extending from the gun body and defining an internal passage;
a nozzle assembly at a distal end of the barrel, the nozzle assembly including a first threaded component coupled to the barrel, a second threaded component threadably engaged with the first threaded component, and a dispensing insert positioned between the first and second threaded components; and
a flow control element movable within the internal passage to selectively permit or block flow of material through the passage.

9. The applicator of claim 8, wherein the first threaded component includes internal thread configured to engage external thread at the distal end of the barrel.

10. The applicator of claim 9, wherein the first threaded component includes external thread configured to engage internal thread of the second threaded component.

11. The applicator of claim 8, wherein the dispensing insert includes a proximal flange retained between the first threaded component and the second threaded component.

12. The applicator of claim 11, wherein the dispensing insert includes a body extending distally from the proximal flange and defining a dispensing passage extending longitudinally therethrough.

13. The applicator of claim 12, wherein the dispensing passage terminates at a distal tip configured to control a spray pattern of the flowable material.

14. The applicator of claim 8, wherein the flow control element comprises a pin operatively coupled to the trigger and configured to selectively block a distal opening of the internal passage.

15. A dispensing device, comprising:
a body portion configured for hand-held operation;
a tubular member coupled to the body portion and having an internal flow path;
a multi-part nozzle assembly at an end of the tubular member, the multi-part nozzle assembly including threaded connections that allow disassembly for component replacement; and
a movable element within the flow path configured to control material flow through the device.

16. The dispensing device of claim 15, wherein the multi-part nozzle assembly comprises an adapter threadably coupled to the tubular member, a nut coupler threadably coupled to the adapter, and a dispensing insert retained between the adapter and the nut coupler.

17. The dispensing device of claim 16, wherein the dispensing insert includes a proximal flange retained between the adapter and the nut coupler and a body extending distally from the proximal flange.

18. The dispensing device of claim 17, wherein the body defines a dispensing passage extending longitudinally therethrough and terminating at a distal tip configured to control a spray pattern.

19. The dispensing device of claim 15, wherein the movable element comprises a pin operatively coupled to a trigger of the body portion and configured to selectively block a distal opening of the internal flow path.

20. The dispensing device of claim 15, further comprising a connection assembly coupled to the body portion and configured to receive a source of flowable material under pressure.
